(19) United States
(12) Patent Application Publication
(10) Pub. No.: US 2007/0112923 A1
(43) Pub. Date: May 17, 2007

(54) FILE DOWNLOAD SYSTEMS AND METHODS

(75) Inventors: Jeng-Ling Lee, Taipei (TW); Chia-Wei Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES, INC., Taipei (TW)

(21) Appl. No.: 11/463,018

(22) Filed: Aug. 8, 2006

(30) Foreign Application Priority Data
Oct. 27, 2005 (TW) 94137658

(51) Int. Cl. G06F 15/16; G06F 15/177

(52) U.S. Cl. 709/206; 709/220

(57) ABSTRACT

A file download system is disclosed. The file download system comprises a client, an email box, and a content provider having at least one file. The content provider receives a download request for the file from the client, and transmits the file to the email box indicated by the content provider. The client connects to the email box and acquires the file therefrom. A file download method for use in a content provider having at least one file, identification data is inputted to the content provider. A download request for the file is received from a client to the content provider. The file according to the download request is transmitted to an email box indicated by the identification data of the content provider. The client connects to the email box and acquires the file therefrom.

### BACKGROUND OF THE INVENTION

1. Field of the Invention

The present disclosure relates generally to file management, and, more particularly to file download systems and methods for managing the authority of file download system in a network platform.

2. Description of the Related Art

Recently, Using network has become a necessary part of life. Surfing websites and downloading files via electronic devices such as notebooks and PDAs with network capability is common.

Generally, when a user wants to download a file from a specific website, the website provides an interface for selecting whether to directly open the file or save the file. Any person has the authority without identification (ID) and a password for opening or saving file in his computer. In this case, anyone can possess the authority to download the file if he can connect to the file through his electronic device. If someone plans to steal manager confidential documents, he can illegally get identification and a password. Inputting the identification and the password has the authority for entering the website. When accessing the website, he can arbitrarily download any file he needs. Furthermore, the website has no security mechanism for his confidential files.

### BRIEF SUMMARY OF THE INVENTION

File download systems and methods are provided.

An embodiment of a file download system comprises a client, an email box, and a content provider having at least one file. The content provider receives a download request for the file from the client, and transmits the file to the email box indicated by the content provider. The client connects to the email box and acquires the file therefrom.

In an embodiment of a file download method for use in a content provider having at least one file, identification data is inputted to the content provider. A download request for the file is received from a client to the content provider. The file according to the download request is transmitted to an email box indicated by the identification data of the content provider. The client connects to the email box and acquires the file therefrom.

File download systems and methods may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a file download system;

FIG. 2 is a schematic diagram illustrating an embodiment of the data structure of a user password table;

FIG. 3 is a schematic diagram illustrating an embodiment of the data structure of a user authority table;

FIG. 4 is a schematic diagram illustrating an embodiment of the data structure of a user data table; and

FIG. 5 is a flow chart showing an embodiment of a file download method.

### DETAILED DESCRIPTION OF THE INVENTION

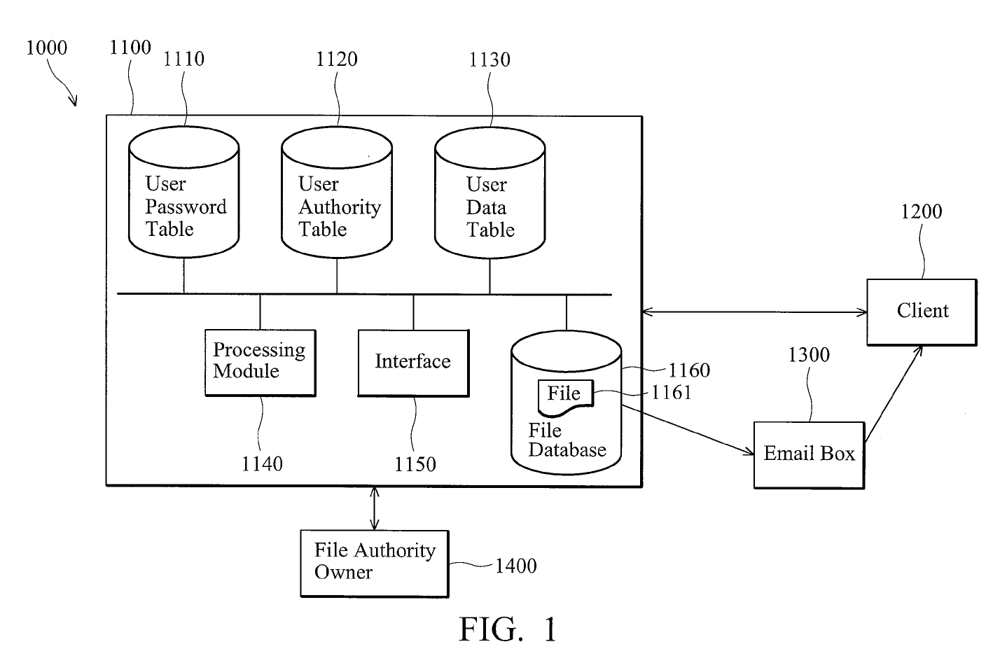

File download systems and methods are provided. FIG. 1 is a schematic diagram illustrating an embodiment of a file download system. The file download system 1000 comprises a content provider 1100, at least one client 1200, an email box 1300 owned by the client 1200, and at least one file authority owner 1400.

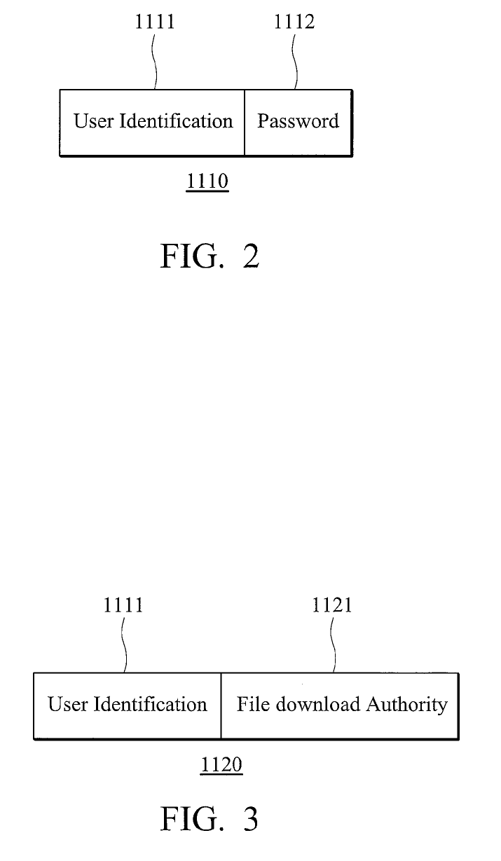

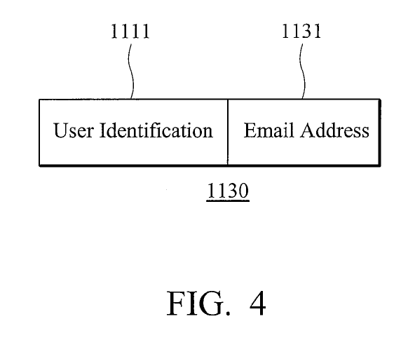

The content provider 1100 comprises a user password table 1110, a user authority table 1120, a user data table 1130, a processing module 1140, an interface 1150, and a file database 1160 comprising at least one file 1161. The content provider 1100 uses the user password table 1110 to authenticate a client upon login. FIG. 2 is a schematic diagram illustrating an embodiment of the data structure of a user password table. As shown in FIG. 2, the data structure of the user password table 1110 comprises a user identification field 1111 and a password field 1112 for respectively storing a login account on the content provider 1100 and a corresponding password. The content provider 1100 uses the user authority table 1120 to determine whether a user has authority to download a specific file. FIG. 3 is a schematic diagram illustrating an embodiment of the data structure of a user authority table. As shown in FIG. 3, the data structure of the user authority table 1120 comprises a user identification field 1111 and a file download authority field 1121 for respectively storing a login account on the content provider 1100 and authority to download a specific file. FIG. 4 is a schematic diagram illustrating an embodiment of the data structure of a user data table. As shown in Fig.4, the data structure of the user data table 1130 comprises a user identification field 1111 and an email address field 1131 for respectively storing a login account on the content provider 1100 and an email address corresponding to the login account. The processing module 1140 performs user authentication according to the user identification 1111 and password 1112 input by a user, download authority determination to determine whether the user has authority to download specific data if the user passes the authentication and wants to download the specific data on the content provider 1100, and file download by directly transmitting the specific data to an email box corresponding to the user. Additionally, the client 1200 can browse and request to download the file 1161 in the file database 1160 via the interface 1150. It is understood that the file authority owner 1400 can be a system administrator of the content provider 1100 or personnel having authority for the file 1161.

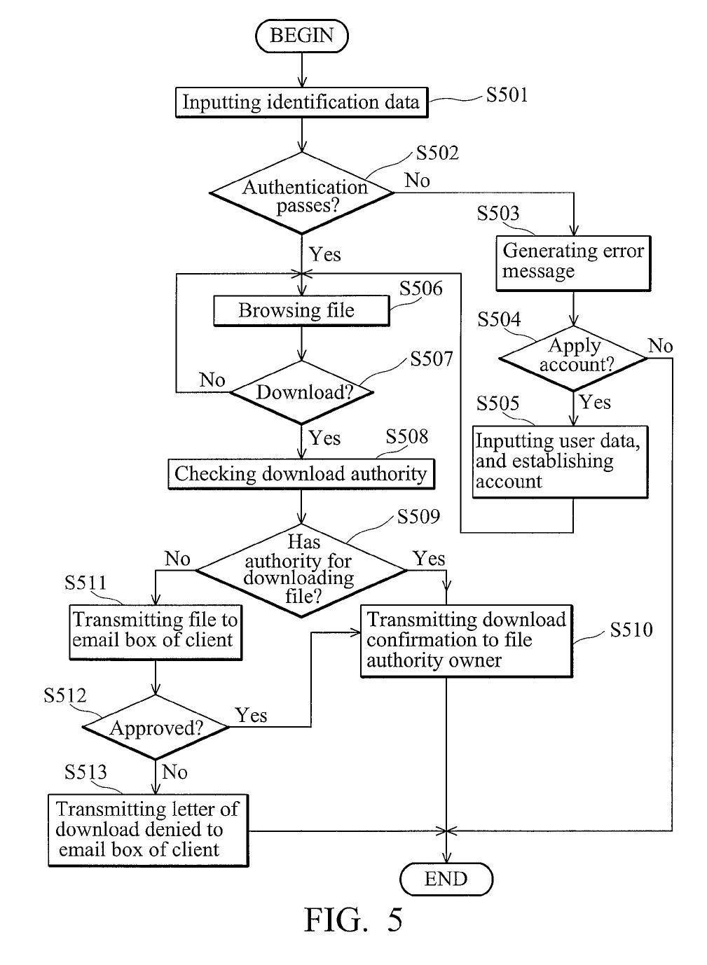

FIG. 5 is a flow chart -showing an embodiment of a file download method. In step S501, the client 1200 inputs identification data, such as user identification and a password to log into the content provider 1100. In step S502, the content provider 1100 authenticates the client 1200 according to the identification data inputted before. It is understood that the authentication is performed by checking whether the user identification is set in the user password table 1110, and if so, determining whether the input password conforms to the set password of the user password table 1110. If the authentication fails, proceeding to step S503, an error message is generated. In step S504, it is determined whether the client 1200 wants to apply for an account. If not, the procedure is completed. If so, the content provider 1100 generates an account for the client 1200 automatically, or based on direction of a system administrator. The procedure goes to step S506.

Judge whether the authentication passes in step S502. If so, go to step S506. In step S506, the client 1200 is granted to entry the content provider 1100, and browses the file 1161 in the file database 1160 via the interface 1150. In step S507, it is determined whether the client 1200 wants to download the file 1161. It is understood that, in some embodiments, the client 1200 may generate a download request for the file 1161 by selecting a link (not shown) corresponding to the file 1161 in the interface 1150. If the client 1200 does not want to download the file 1161, the procedure returns to step S506 the client 1200 can use the interface 1150 to browse other files in the file database 1160. If the client 1200 wants to download the file 1161, proceeding to step S508, the content provider 1100 determines whether the client 1200 has authority to download the file 1161 by checking whether the data recorded in the authority field 1121 of the user authority table. 1120 corresponding to the user identification 1111 of the client 1200 is valid in step S509. If so, proceeding to step S510, the content provider 1100 retrieves an email address inputted by the client 1200 from the user data table 1130 according to the user identification of the client 1200, and transmits the file 1161 to the email box 1300 according to the retrieved email address. If not, proceeding to step S510, the content provider 1100 transmits a confirmation letter to the file authority owner 1400 for approving the download of the file 1161. If the confirmation is not approved by the file authority owner 1400, proceeding to step S513, the content provider 1100 transmits a letter of download denied to the email box 1300 inputted by the client 1200. If the confirmation is approved by the file authority owner 1400, proceeding to step S510, the content provider 1100 retrieves an email address of the client 1200 from the user data table 1130 according to the user identification of the client 1200, and transmits the file 1161 to the email box 1300 according to the retrieved email address. It is understood that after the file authority owner 1400 makes a decision to the download confirmation, the file authority owner 1400 transmits a reply, a message or an email message comprising the confirmation result to the content provider 1100, and the content provider 1100 determines the confirmation result accordingly. Therefore, the client 1200 can connect to the email box 1300, and acquire the file 1161 transmitted from the content provider 1100 therefrom. It is understood that a system (not shown) providing the email box 1300 may have a user authentication mechanism. When the client 1200 connects to the email box 1300, identification data must be input to the system for authentication to login the email box 1300 for acquiring the file 1161.

The file download system and method of the present invention are disclosed. Compared to prior art, the file download system has a download mechanism for security. A user intends to download a file. The download request for the file is received from a client. The file is transmitted to an email box connected to the client. If anyone wants to download the file, he must possess the authority to download the file. If he has the authority, the file will be transmitted to a default email box set before. The file download system can prevent the file stolen by other people who intend to get the confidential file illegally. Moreover, the file download system of the present invention has a secure mechanism.

File download systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission media, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A file download system, comprising:
a client;
an email box; and
a content provider comprising at least one file, receiving a download request for the file from the client, and transmitting the file to the email box indicated by the content provider,
wherein the client connects to the email box and acquires the file therefrom.

2. The system of claim 1 wherein the content provider checks whether the client has authority to download the file, and if the client has authority, transmits the file to the email box.

3. The system of claim 1 wherein the content provider checks whether the client has authority to download the file, transmits the download request to at least one authority owner for confirmation if the client has no authority, and transmits the file to the email box if the download request is approved.

4. The system of claim 1 wherein the content provider checks whether the client has authority to download the file, transmits the download request to at least one authority owner for confirmation if the client has no authority, and transmits a letter of download denied to the email box if the download request is not approved.

5. The system of claim 1 wherein the client inputs identification data comprising an email address to the content provider for transmitting the file into the email box corresponding to the email address.

6. The system of claim 5 wherein the content provider logs into the email box set according to the identification data and the client acquires the file from the email box.

7. A file download method for use in a content provider comprising at least one file, comprising:
inputting identification data to the content provider;
receiving a download request for the file from a client; and
transmitting the file to an email box indicated according to the identification data of the content provider,
wherein the client connects to the email box and acquires the file therefrom.

8. The method of claim 7 further comprising:
the content provider checking whether the client has authority to download the file; and
if the client has authority, transmitting the file to the email box.

9. The method of claim 7 further comprising:
the content provider checking whether the client has authority to download the file;
if the client has no authority, transmitting the download request to at least one authority owner for confirmation; and
transmitting the file to the email box if the download request is approved.

10. The method of claim 7 further comprising:
the content provider checking whether the client has authority to download the file;
if the client has no authority, transmitting the download request to at least one authority owner for confirmation; and
transmitting a letter of download denied to the email box if the download request is not approved.

11. The method of claim 7 wherein the identification data comprises user identification, password, and an email address corresponding to the email box receiving the download file from the content provider.
